(19) United States
(12) Patent Application Publication
(10) Pub. No.: US 2009/0124155 A1
(43) Pub. Date: May 14, 2009

(54) PROCESS FOR PRODUCING SHEATH-CORE STAPLE FIBERS WITH A THREE-DIMENSIONAL CRIMP AND A CORRESPONDING SHEATH-CORE STAPLE FIBER

(75) Inventors: HENDRIK TIEMEIER, Remscheid (DE); Ekkehard Labitzke, Koditz (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Oerlikon Textile GmbH & Co., KG

(21) Appl. No.: 12/114,973

(22) Filed: May 5, 2008

Related U.S. Application Data
(63) Continuation of application No. PCT/EP2006/010564, filed on Nov. 3, 2006.

(30) Foreign Application Priority Data
Nov. 7, 2005 (DE) 10 2005 052 857.0

(51) Int. Cl. D04H 1/00; B29C 47/08; B32B 5/02

(52) U.S. Cl. 442/338; 264/148; 264/150; 428/362; 442/360

(57) ABSTRACT

The invention relates to a process for producing sheath-core staple fibers with a three-dimensional crimp and to a sheath-core staple fiber of this type. In this case, the fiber is extruded with a symmetrical sheath-core arrangement consisting of two different polymer melts with a first polymer component for the core and with a second polymer component for the sheath. In order to generate an as far as possible intensive three-dimensional crimp in the fiber, the cooling of the fiber takes place by means of a sharp cooling air stream with a blowing air velocity of at least 3 m/sec., after the combining of the fibers into a tow the multistage treatment in a fiber line taking place under a maximum temperature load which lies below the glass transition temperature of the second polymer component in the sheath of the fiber. A high degree of three-dimensional crimping can consequently be achieved after the multistage treatment and before the cutting of the fiber.

### CROSS-REFERENCE TO RELATED APPLICATIONS

The present application is a Continuation of International Application No. PCT/EP2006/010564, filed Nov. 3, 2006, and which designates the U.S. The disclosure of the referenced application is incorporated herein by reference.

### FIELD OF THE INVENTION

The invention relates to a process for producing sheath-core staple fibers with a three-dimensional crimp by the extrusion and cooling of the fiber and subsequent multistage treatment in a fiber line up to the cutting of the fiber into staple fibers, and to a sheath-core staple fiber with a three-dimensional crimp, comprising a plurality of polymer components.

### BACKGROUND OF THE INVENTION

Synthetic staple fibers are used increasingly for the production of fibrous nonwoven materials, in particular the external nature and interconnection possibility of the fibers being particular characteristic variables. In this context, it has been shown that the staple fibers with a sheath-core characteristic, in which the sheath of the fiber has a thermobondable polymer material, are particularly suitable for obtaining a preconsolidated nonwoven layer by thermal bonding. Such nonwoven layers are used preferably for multilayer nonwoven materials, since essentially intermixings of the fiber between the individual layers occur. A sheath-core fiber of this type, for example, is known from JP 2-191717.

In the known sheath-core staple fiber, the fiber is extruded from two different polymer components, in order to obtain in the sheath of the fibers a material which is favorable for thermal bonding. Furthermore, the polymer components are selected in such a way that, after cooling, these have different shrinkage behaviors, thus leading, during further treatment, to the self-crimp of the fiber. Such a property of the fiber, also known as so-called three-dimensional crimping, is in this case particularly reinforced in that the core is formed eccentrically within the fiber cross section and therefore a material quality which is essentially different from both sides of the fiber is established and further reinforces the self-crimping effect. After the melt-spinning of the fiber, this is drafted, crimped mechanically and, after shrinkage treatment at approximately 100° C., cut into staple fibers.

However, the eccentric arrangement of the core within the fiber cross section possesses the disadvantage that an insufficient sheathing with the second polymer component in each case occurs in places, thus obstructing the further processing process particularly with regard to the thermal bonding properties. A further disadvantage is afforded in that the 3D crimp generated is based essentially on the differences between the polymer components.

A sheath-core staple fiber of this type and its production process are likewise known from U.S. Patent Publication No. 2004/0234757 A1, in which the eccentric formation of the polymer components within the fiber cross section for generating a 3D crimp is to be further improved in that the fiber is acted upon on one side by a cooling air stream. As a result of subsequent thermal treatment for fixing the crimp at temperatures of up to 200° C., however, the structural variations caused by cooling are to the greatest possible extent cancelled, so that self-crimping continues to be determined essentially only by the differences in the polymer components. Moreover, the fiber has an eccentrically formed sheath-core structure which leads to the disadvantages already mentioned above.

A sheath-core staple fiber in which the fiber has a symmetrical sheath-core arrangement may be gathered from EP 0 891 433 B1. In this case, however, the fiber consists of a polymer component which is decomposed in the marginal region by oxidation and thus exhibits the sheath-core structure. However, fibers of this type possess very poor properties for the formation of self-crimping, and therefore mechanical crimps are unavoidable. Mechanical crimping, which is also designated as what is known as two-dimensional crimping, basically leads to a lower texturing capacity and fullness of the fiber.

An object of the invention, then, is to provide a process for producing a sheath-core staple fiber with a three-dimensional crimp and a corresponding sheath-core staple fiber, in which good thermal bondability is ensured in spite of high intrinsic crimping.

### SUMMARY OF THE INVENTION

The above object and others are achieved, according to the invention, by means of a process and a sheath-core staple fiber as described and claimed herein.

Advantageous developments of the invention are defined by the features and feature combinations of the respective exemplary embodiments.

The invention is distinguished in that the sheath-core staple fiber has at its circumference a uniformly distributed polymer component, the properties of which can be coordinated with the further processing process. Thus, advantageously, thermal bonds can be produced reliably for each fiber by means of individual melt points. In this case, it was shown, surprisingly, that the different crystallinity generated during the consolidation of the fiber, particularly in the sheath region, by the sharp blowing leads to high self-crimping which is further reinforced by the material difference occurring as a result between the sheath and the core. It is in this case preferable, however, that a multistage treatment, carried out after the melt-spinning of the fiber, is performed in a fiber line at temperatures which lie below the glass transition temperature of the polymer component in the sheath of the fibers. Consequently, a breakdown of the structural variations on account of the different cooling history of the fiber sides is avoided. During subsequent treatment, particularly drafting, the different crystallinities lead to a pronounced crimping of the fiber.

For this purpose, the sheath-core staple fiber according to the invention has, in the symmetrically formed sheath-core structure, a fine crystalline structure on one fiber side and a substantially coarser crystalline structure on an opposite fiber side. Consequently, after multistage treatment, the fiber shows an intensively imprinted 3D crimp which leads to a textured and bulky character of the fiber. Fibers of this type can thus also advantageously be used as filling material. On account of the outstanding thermobondability, the staple fiber according to the invention is also preferably suitable for multilayer nonwoven products.

It will show that the three-dimensional crimp in the sheath-core staple fiber can be further improved in that the fiber is extruded with a hollow core which has a hollow portion, formed at the center, of at least 2% of the fiber cross section. The hollow portion may in this case occupy at most a size of 30% of the fiber cross section. The hollow portion affords separation between the fiber side acted upon by the cooling air and the opposite fiber side, so that the structural variations caused by cooling occur to an even greater extent on the two fiber sides. Moreover, with texturing remaining the same, the elasticity of the fiber rises.

The hollow cross section of the fiber is preferably extruded through a nozzle bore having a C-shaped orifice cross section. Consequently, a filling of a gaseous medium, preferably ambient air, can be implemented in the hollow portion of the fiber cross section. The air contained in the hollow portion thus has an additional insulating action between the fiber sides, so that the structural variation generated as a result of the one-sided cooling can emerge to an even greater extent. Furthermore, the filling within the fiber causes a rise in elasticity, so that, in particular, a relatively high elastic relaxation can be detected on the fiber.

Depending on the further proceeding requirements, the sheath-core staple fiber is extruded with a sheath which surrounds the core with an essentially coaxially formed annular surface in the range of 5 to 50% of the fiber cross section. A high flexibility in the configuration of the sheath-core staple fiber is consequently afforded, in order to implement different combinations of polymer components in different fractions.

So as to increase the cooling differences between the blown-on fiber side and the fiber side not blown on, which are caused by sharp blowing at a blowing air velocity of at least 3 m/s, according to an advantageous development of the process according to the invention the cooling of the fiber is carried out by means of a cooling air which has an air temperature in the range of 5° C. to 30° C. The cooling air is preferably led up at a temperature below 20° C. to the freshly extruded fibers.

The extrusion of the fibers can in this case be carried out both by means of rectangular spinnerets and by means of ring spinnerets. When rectangular spinnerets with a multiplicity of nozzle orifices are used, the filament bundle extruded through the nozzle orifices is lead along a cross-flow blowing arrangement and is cooled from outside by the cooling air stream.

When a ring spinneret with a multiplicity of nozzle orifices is used, the fibers extruded to form a filament balloon are preferably cooled by means of a candle-type blowing arrangement in which the cooling air stream flows through the annular filament group radially from the inside outward.

Preferably the fibers, after extrusion, are taken up at a take-up speed in the range of 100 m/min. to 1000 m/min., so that the further processing of the fiber on a fiber line can be carried out both continuously and discontinuously.

In order to obtain as favorable thermal bonding properties as possible in the sheath-core staple fiber, the sheath is extruded from a low-melting polymer, for example a copolyester or olefin. By contrast, the core can be extruded preferably from a polyolefin, for example a polypropylene (PP) polymer, which is to be considered as a cost-effective filling material.

The sheath-core staple fiber according to the invention is distinguished not only by the high three-dimensional crimping, but, in particular, by its high dimensional stability, since, during processing into a nonwoven, essentially only the polymer component in the sheath region of the fiber is utilized in order to produce a thermal bond. In this case, the polymer component in the core of the fiber remains substantially uninfluenced. The self-crimp generated in the fiber ensures, in particular, a fiber structure which is bulky and relatively lightweight, so that high-bulk nonwovens with high porosity and good recovery capacities can be produced from it.

The relatively light specific weight of the fiber is achieved, in particular, on the one hand, by a relatively large hollow portion of max 30% of the fiber cross section and, on the other hand, by the choice of the material which, in particular, has in the sheath a material density which is higher than the material density in the core. It was in this case shown to be particularly advantageous if the material density in the sheath is higher by a factor of between 1 and 1.5 than the material density of the core.

The self-crimp of the fiber, which occurs due to the cooling which is quicker on one side and to possible desired unevenness in the material distribution over the fiber cross section of the fiber, lies in a range of 5 to 12 loops of a fiber length of 1 inch, which corresponds to a fiber length of 25.4 mm. Such crimps are particularly suitable for forming textured nonwovens from them.

It became apparent that the use of such sheath-core staple fibers is preferably in the lower titer range, and therefore the process variant is particularly advantageous in which, after multistage treatment, a fiber with a filament titer in the range of 2 den to 20 den is generated.

The fibrous nonwoven product according to the invention is distinguished particularly in that an interconnected fiber structure can be produced in a simple way, for example, by the action of hot air. Moreover, multilayer fibrous nonwovens can be produced both as a molding or as a semi-finished product. The fibrous nonwoven products could likewise be used as filling material on account of their texturing.

The staple fibers according to the invention are preferably processed into a web by carding, while the consolidation of the staple fibers within the web can take place in a simple way by thermal consolidation by the melting of the intersection points of the staple fiber. For this purpose, the web can be heated, for example, by heated air or by radiant heating elements. There is also the possibility, however, of carrying out ultrasonic consolidation in which the fibers are heated by friction solely at their intersection points with other fibers, to an extent such that melting occurs.

Owing to the relatively high degree of self-crimping, the fiber is preferably suitable for generating three-dimensional fiber structures in the nonwoven. In this case, the nonwoven possesses the particular advantage that, even after mechanical load, reforming as far as possible occurs. This effect can be utilized for a very long period of time by virtue of the special property of the fiber.

The nonwoven formed from the staple fibers is therefore designed, in particular, as heat insulation, sound insulation or upholstery material. Materials of this type are distinguished, in particular, by the low volume per unit area which is possible due to the sheath-core staple fiber according to the invention. Nonwovens of this type can to that extent be produced with relatively low use of raw materials.

### BRIEF DESCRIPTION OF THE DRAWINGS

The process and products according to the invention are explained in more detail below by means of some exemplary embodiments, with reference to the accompanying drawings in which:

FIG. 1 illustrates diagrammatically a side view of a melt-spinning apparatus for the extrusion of a multiplicity of fibers in accordance with one exemplary embodiment;

FIG. 2 illustrates diagrammatically a cross-sectional view of the exemplary embodiment according to FIG. 1;

FIG. 3 illustrates diagrammatically a side view of a fiber line for the multistage treatment of a multiplicity of sheath-core fibers in accordance with one exemplary embodiment;

FIG. 4 illustrates diagrammatically a cross section of an exemplary embodiment of a sheath-core staple fiber;

FIG. 5 illustrates diagrammatically a cross section of a further exemplary embodiment of the sheath-core staple fiber according to the invention; and

FIG. 6 illustrates diagrammatically a cross-sectional view of a further exemplary embodiment of a melt-spinning apparatus for the extrusion of a multiplicity of sheath-core fibers.

### DETAILED DESCRIPTION OF PREFERRED EMBODIMENTS

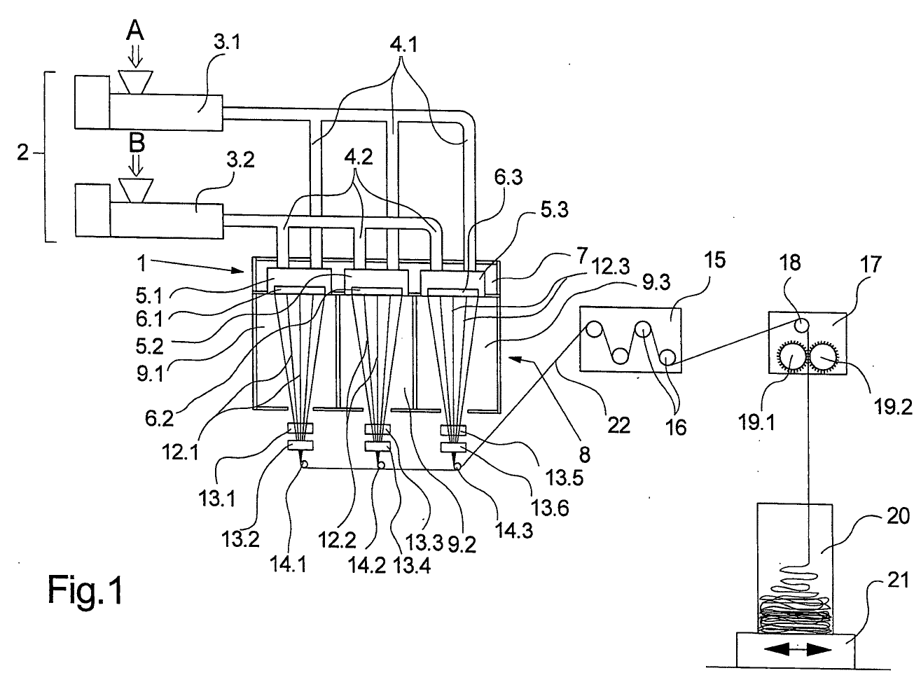

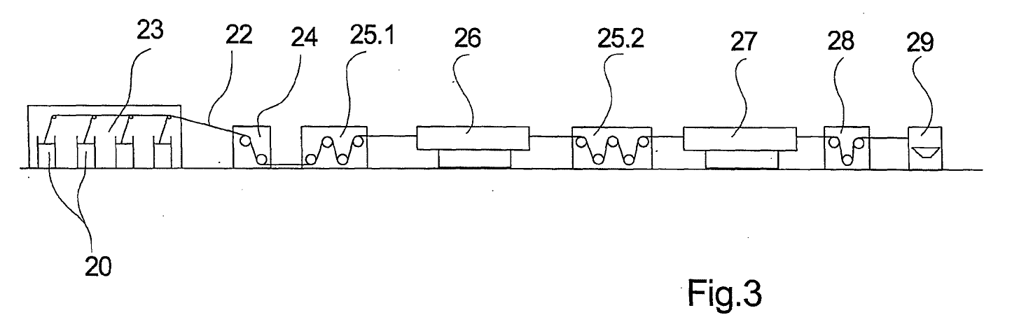

The apparatus parts illustrated in FIGS. 1 and 3 form an exemplary embodiment of an apparatus for carrying out the process according to the invention. Staple fiber production plants of this type have the particular feature that the fibers extruded by melt-spinning are intermediately stored before multistage treatment. Consequently, during the melt-spinning of the fiber and during the multistage treatment of the fiber, different production speeds and different material flows can be implemented and be optimized with the respective process segment. Thus, in a first stage of the production process, a multiplicity of sheath-core fibers are extruded and are deposited as what is known as a tow into a can for intermediate storage.

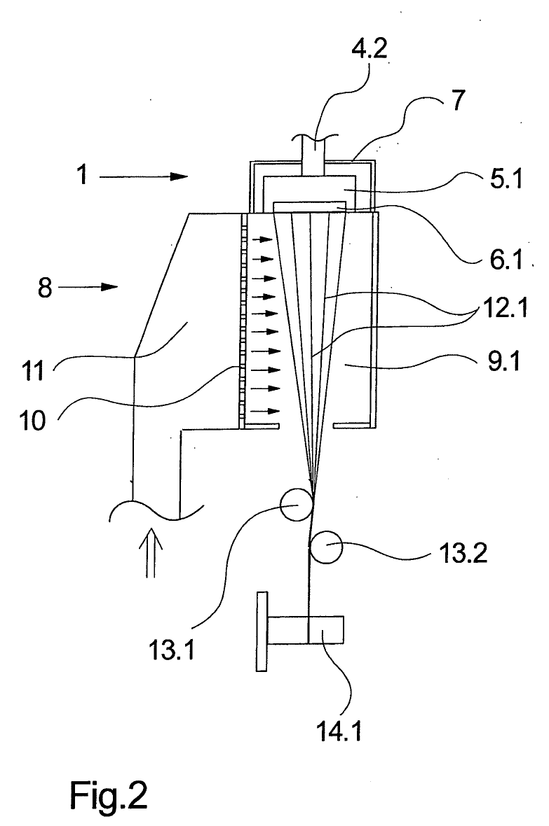

FIGS. 1 and 2 show an exemplary embodiment of a melt-spinning apparatus of this type diagrammatically in a plurality of views. FIG. 1 shows the melt-spinning apparatus in a side view and FIG. 2 the melt-spinning apparatus in a cross-sectional view. Insofar as no express reference is made to one of the figures, the following description applies to both figures.

The melt-spinning apparatus has a spinning device 1 which is connected to a melt preparation 2. The melt preparation 2 is formed in this exemplary embodiment by two melt sources 3.1 and 3.2 which are connected to the spinning device 1 via the melt distributor systems 4.1 and 4.2. The melt sources 3.1 and 3.2 are illustrated in this exemplary embodiment as extruders which in each case melt a polymer material. Thus, a first polymer component A can be prepared by the melt source 3.1 and a second polymer component B by the melt source 3.2, in each case to form a polymer melt which is supplied to the spinning device 1.

The spinning device 1 has a plurality of spinneret means 5.1, 5.2 and 5.3 arranged next to one another in a spinning beam 7. The spinneret means 5.1, 5.2 and 5.3 are coupled to the melt distributor systems 4.1 and 4.2. Conveying and guiding means are provided within the spinneret means 5.1, 5.2 and 5.3, in order to extrude the supplied melt streams in each case through a multiplicity of nozzle orifices in a rectangular nozzle plate attached to the underside of the spinneret means. The extrusion of sheath-core fibers is generally known in the prior art, and therefore a detailed description and design of the apparatus parts are dispensed with at this juncture.

For the extrusion of a sheath-core fiber with a hollow core, in particular, nozzle orifices are used which have a C-shaped orifice cross section. Consequently, the fiber can be generated with a filling of a gaseous fluid. The gaseous fluid is in this case formed from the gas atmosphere prevailing in the surroundings of the fiber. Since these surroundings are determined essentially by the ambient air, air therefore passes into the hollow portion of the core of the fiber.

Each of the rectangular nozzle plates 6.1, 6.2 and 6.3 assigned to the spinneret means 5.1 to 5.3 generates a multiplicity of sheath-core fibers which emerge as filament bundles in a fiber group and are taken up. Thus, the filament bundle 12.1 is extruded through the nozzle plate 6.1, the filament bundle 12.2 is extruded through the nozzle plate 6.2, etc.

Below the spinning beam 7 is arranged a cooling device 8. The cooling device 8 has for each filament bundle 12.1 to 12.3 in each case a cooling well 9.1, 9.2 and 9.3 through which the filament bundles are guided for cooling. On one side of the cooling wells 9.1, 9.2 and 9.3 is formed a blowing wall 10 which is coupled directly to a pressure chamber 11. The pressure chamber 11 is connected to a cooling air source (not illustrated here) through which a cooling air is supplied with excess pressure in the pressure chamber 11, so that the blowing wall 10 generates a cooling air stream which is directed substantially transversely with respect to the running direction of the filament bundles 12.1 to 12.3.

Below the cooling device 8 are provided a plurality of preparation rollers 13.1 to 13.6 and a plurality of deflection rolls 14.1 to 14.3, by means of which the filament bundles 12.1, 12.2 and 12.3 are converged into a tow 22. The take-up of the filament bundles 12.1 to 12.3 takes place substantially by means of the take-up mechanism 15 having a plurality of take-up rollers 16 over which the tow is guided. The take-up mechanism 15 is followed by a conveying means 17 which has a deflection roller 18 and two following winding rollers 19.1 to 19.2. The winding rollers 19.1 and 19.2 are driven at identical circumferential speeds, the tow guided between the winding rollers 19.1 and 19.2 being conveyed into a can 20 held below the conveying means 17. The can 20 is held in a can mounting 21 which executes a movement of the can, so that the tow 22 can be deposited, distributed uniformly, within the can 20.

For the further treatment of the fibers, after the filling of the can 20, the latter is placed into what is known as the can creel, in order, in a second process sequence, to carry out a multistage treatment on the fibers. FIG. 3 shows the apparatus parts of an exemplary embodiment of a fiber line for cutting the fiber strands into the sheath-core fiber according to the invention after multistage treatment. At the start of the fiber line, a can creel 23 holding a multiplicity of cans 20 is arranged. The can creel is assigned a collective take-up mechanism 24, by means of which the fibers stored in the cans are taken up as tow and converged. The tow strands 22 are subsequently supplied to a plurality of treatment devices and, at the end, are cut into staple fibers of predetermined length by a cutting device 29. The treatment devices comprise a first drawframe 25.1, a treatment chamber 26, a second drawframe 25.2, a drying device 27 and a tension setting device 28.

The first drawframe 25.1 is arranged directly next to the collective take-up mechanism 24. The drawframe 25.1 is followed by the second drawframe 25.2, each of the drawframes 25.1 and 25.2 having a plurality of drawing rollers. The tow strands 22 are guided, with single looping, on the drawing rollers of the drawframes 25.1 and 25.2. The drawing rollers of the drawframes 25.1 and 25.2 are driven, the drawing rollers of the drawframes 25.1 and 25.2 being operated at different circumferential speeds as a function of the desired draft ratio. For the simultaneous thermal treatment of the fibers, the drawing rollers of the drawframes 25.1 and 25.2 may have a cooled roller casing or a heated roller casing, depending on requirements.

For treatment, for example for heating the fibers, between the first drawframe 25.1 and the second drawframe 25.2 is formed a treatment duct 26 in which the fibers receive conditioning. There is therefore the possibility for thermally controlling the fiber strands to a predetermined temperature by means of hot air or by means of hot steam. Alternatively, conditioning may also involve a wetting of the fiber strands.

The drawframe 25.2 is followed by a drying device 27 for reducing the moisture content in the fiber strands, in order to obtain a final fixing of the crimp in the fiber.

At the end of the fiber line, a tension setting device 28 and the cutting device 29 are provided, in order to cut the fiber strands of the sheath-core fiber continuously into staple fibers of predetermined fiber length.

The fiber line illustrated in FIG. 3 is by way of example in terms of the set-up and arrangement of the treatment device. Thus, additional treatment devices can be added between the can creel stand 23 and the cutting device 29. For multistage drafting, for example, the second drawframe could be followed by a third drawframe, in which case additional steam treatment would be possible between the second and the third drawframe. Moreover, the drying device 27 could be preceded by a laying device, in order to vary the guide widths of the tow 22 within the fiber line. In order to generate extreme crimps in the sheath-core fibers, it would likewise be possible for the drying device to be preceded by a crimping device.

So that the process according to the invention can be carried out, the following process settings required for the melt-spinning apparatus and the fiber line are preferred. Thus, to generate a three-dimensional crimp in the sheath-core fiber, after extrusion a sharp cooling air stream is blown onto the sheath-core fiber. For this purpose, a cooling air stream with a blowing air velocity of at least 3 m/s is generated through the blowing wall 10. It became apparent that, at take-up speeds in the range of 300 to 800 m/min., the blowing air velocity is set in the range of 3 to 8 m/s. The sharp blowing of the fiber strands after extrusion leads to an uneven cooling of the fiber, so that the fiber side blown on directly cools more rapidly than the opposite fiber side not blown on. This gives rise, in the crystalline build-up of, in particular, the sheath layer of the fiber, to a differentiated structure which, particularly after multistage treatment, leads to an intensive 3-dimensional crimping of the fiber. In this case, however, the multistage treatment must be carried out at a temperature which lies markedly below the glass transition temperature of the polymer component in the sheath of the fiber. This ensures that the molecular structure formed during cooling is not destroyed. To that extent, in particular, the sheath structure of the fiber is critical for the formation of the self-crimp. In the production of a sheath-core fiber in which the first polymer component A for the core is formed by a polypropylene (PP) and the second polymer component B for the sheath by a polyethylene terephthalate, the multistage treatment was carried out at a maximum temperature load on the fibers of <70° C. The glass transition temperature T_{g} of the polyethylene terephthalate (PET) amounts to 75° C., and therefore the molecular structure in the multistage treatment, formed during cooling, was maintained. Thus, the drafts of the sheath-core fibers lead to an uneven drawing of the fiber inside with respect to the fiber outside, which, particularly after relaxation in the drying device, has the effect of an intensive 3-dimensional crimping in the fiber.

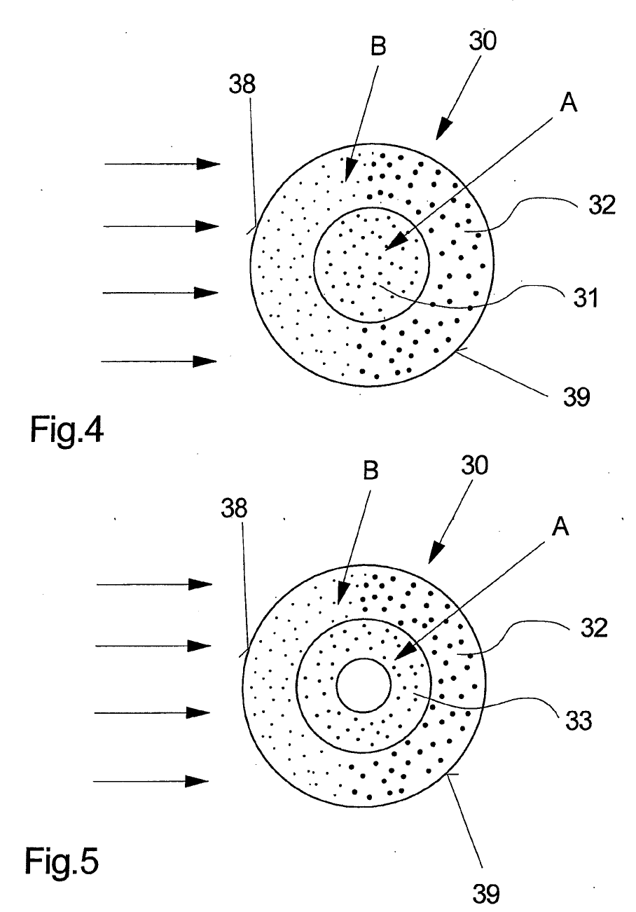

FIG. 4 shows diagrammatically a fiber cross section of a sheath-core fiber. The fiber cross section of the sheath-core fiber 30 has a symmetrical arrangement between a core 31 and a sheath 32. The core 31 is therefore sheathed uniformly by the sheath 32 with an annular surface. To cool the fibers extruded at melting temperatures in the range of 220 to 300° C., they are acted upon at a front fiber side 38 with a cooling air stream. The cooling air stream is blown in the direction of the sheath-core fiber 30 at a blowing air velocity in the range of 3 to 8 m/sec. The air temperature of the cooling air is in this case in the range of 5° C. to 30° C., a temperature of below 18° C. preferably being set. During the consolidation of the sheath-core fiber 30, then, molecular differences between the front fiber side 38 and the rear fiber side 39 occur. In particular, the polymer component B in the sheath 32 forms a different crystallinity on the fiber sides 38 and 39. In the region of the front fiber side 38, due to the sharp cooling, a relatively large number of small crystals are formed. In the region facing away on the fiber side 39, due to the slower cooling, relatively few, but, instead, larger crystals are formed. This inner structure, formed as a result of consolidation, of the second polymer component B and also the material-specific differences between the second polymer components B in the sheath and the first polymer component A in the core 31 are utilized in the following multistage treatment in order to form a highly intensive and uniform 3-dimensional crimp in the sheath-core fiber.

The intensification of the three-dimensional crimping in the fiber can be further reinforced, particularly in the case of hollow fibers, since, during cooling, even greater differences can be generated between the fiber sides lying opposite one another. FIG. 5 shows an exemplary embodiment of a sheath-core fiber of this type. The sheath-core fiber 30 has a hollow core 33 which is surrounded symmetrically by a sheath 32. On account of the hollow portion within the hollow core 33, no appreciable heat conductions take place within the fiber cross section during the cooling of the fiber, so that cooling over the fiber cross section occurs both more quickly and with greater differences between the front fiber side 38 and the rear fiber side 39. To that extent, the sheath-core fiber with a hollow portion is particularly suitable for forming bulky and textured sheath-core staple fibers. It was shown that even a hollow portion of at least 2% of the fiber cross section affords a marked improvement, as compared with a solid cross section. In order, on the one hand, to obtain a sheathing, required for the further treatment of the staple fiber, of the core fiber and, on the other hand, to generate as high cooling deficits as possible between the fiber sides, it became apparent that the core can be extruded with a maximum hollow portion of 30% of the fiber cross section. In the process according to the invention and in the fiber according to the invention, the thermobonding properties advantageous in the further processing of the sheath-core staple fiber are ensured in that the sheath surrounds the core with an substantially coaxially formed annular surface in the range of 5 to 50% of the fiber cross section. Thermal bonds can consequently be made reliably and sufficiently in the further processing process.

In particular, the sheath-core structure with a hollow portion in the fiber leads to a fiber with a relatively low specific weight, so that large-volume nonwovens are produced with it. This effect can be further improved in that a polymer component having a lower material density in relation to the sheath is selected for the core of the fiber. Taking into account the fact that, in particular, the sheath component is formed from a low-melting polymer, appreciable density differences can be achieved. Thus, differences in the range of a factor of 1 to 1.5 can be implemented, that is to say the polymer component of the sheath has a density which is higher by the factor of 1 to 1.5 than the density of the core component.

Moreover, the gaseous fluid enclosed in the cavity of the sheath-core fiber causes an increase in the elastic property of the fiber, this being manifested particularly in the elastic relaxation of the fiber. Thus, elastic relaxations which lay in the region of 60% were measured on a fiber of this type. The dimensional stability of the fiber is assisted, furthermore, in that, during further processing, essentially only the sheath component of the fiber is utilized for bonding the fibers in the thermal consolidation process. Thus, for the sheath component, a polymer is selected which has a low melting point or lower melt flow index values (MFI) in relation to the core polymer. Thus, even during the thermal consolidation of nonwovens, the shape of the fiber in the core region is substantially uninfluenced.

Moreover, the gaseous fluid which is enclosed in the hollow part of the fiber and is formed particularly by air constitutes, during the cooling of the fiber, advantageous insulation between the unevenly treated fiber sides of the fiber. The self-crimping effect is to that extent further reinforced. The self-crimp of fibers of this type has a degree of crimping lying in the range of 7 to 10 arcs per fiber length of 1 inch.

In the fiber cross sections illustrated in FIGS. 4 and 5, the polymer component A in the core of the fiber is preferably formed by a polyolefin and the polymer component B in the sheath of the staple fiber is formed by a polyester. In this case, modifications of such polymers may also be used. It is basically possible, however, for special applications, to form the polymer component A from a polyester and the polymer component B from a polyolefin.

For producing nonwoven products from a fiber of this type, the combination has proved particularly appropriate in which the core is formed from a polypropylene (PP) polymer and the sheath from a polyethylene terephthalate (PET) polymer. This makes it possible to open up broad areas of use of the nonwoven products both in the technical and in the hygienic sector. The sheath-core staple fiber according to the invention is likewise particularly suitable for forming very bulky nonwovens which are used, for example, as filling material for upholstered furniture, cushions or blankets. However, on account of the outstanding thermobonding properties of the fiber, applications as multilayer nonwovens are also possible, where, in particular, intermixing effects, such as occur, for example, during needling or water jet needling, are avoided completely. Thus, nonwoven products in a multilayer arrangement without any appreciable intermixing of the layers can be produced.

The staple fiber according to the invention is preferably processed into a carded web, while the subsequent thermal consolidation can be carried out in a simple way. On account of the comparatively low melting point of the outer material of the sheath-core staple fiber, the web can be heated even by convection by means of a throughflow of heated air. There is likewise the possibility of generating the heating of the web by means of radiant heating elements. It is particularly advantageous, however, to treat the web by ultrasonic consolidation, so that the fibers are heated by friction solely at their intersection points with other fibers, to the extent that melting occurs.

In the nonwovens produced, the sheath-core structure of the fiber gives rise, in particular, to dimensional stability, since the required energy for melting the fibers is low and therefore the core of the fiber remains substantially uninfluenced. The elastic properties and the self-crimp of the fiber lead to high-bulk nonwovens with high porosity and with very good recovery capacities which remain substantially unchanged even under repeated mechanical load. The staple fiber is to that extent suitable particularly for producing a three-dimensional fiber structure in the nonwoven.

These nonwovens produced are preferably designed as heat insulation material or sound insulation material. On account of the dimensional stability, however, they are also suitable preferably as upholstery material, for example for interior upholstery in the automobile sector. In this case, in particular, the thermal stability of the fiber is also manifested advantageously.

The process according to the invention is described with reference to an exemplary embodiment of an apparatus in which the fibers are guided discontinuously from melt-spinning to cutting. There is nevertheless basically also the possibility of producing a sheath-core fiber of this type in the continuous process flow. In this case, the fiber strands are drawn directly into the fiber line immediately after extrusion and take-up. The process according to the invention thus extends to all apparatuses known for the production of staple fibers, in particular the settings for cooling and for multistage treatment being designed according to the invention.

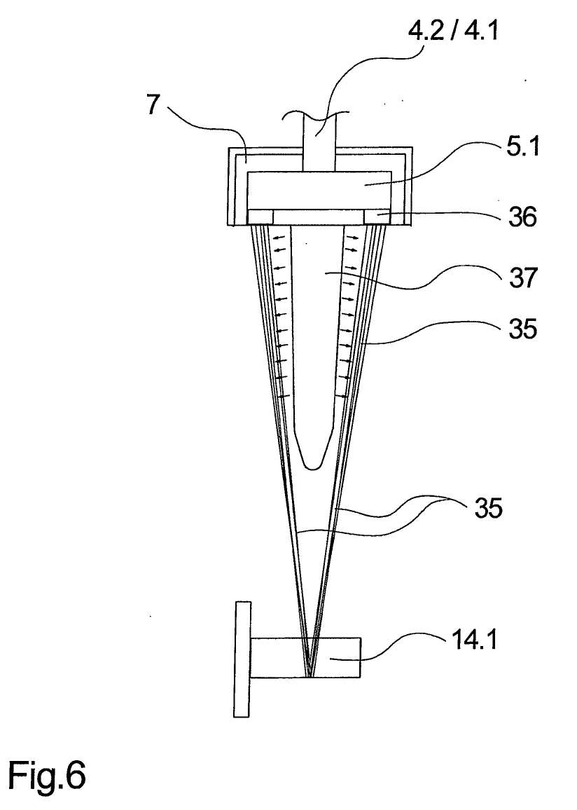

In particular, the cooling of the freshly extruded fibers can alternatively also be brought about by other blow-on arrangements acting on the fiber on one side. Thus, the apparatus illustrated in FIG. 1 can also be implemented alternatively with a ring spinneret. In this respect, FIG. 6 illustrates an exemplary embodiment in which the spinneret means 5.1 has a ring spinneret plate 36 on its underside. The ring spinneret plate 36 leads to the extrusion of the sheath-core fiber to form a filament balloon 35. To cool the fiber strands in the filament balloon 35, a blowing candle 37, which generates a uniform cooling air stream on its casing, is arranged within the filament balloon 35. The cooling air stream thus passes from the inside outward through the filament balloon 35 so that it blows onto the fiber strands on one side. The tie-up of the blowing candle 37 to a cooling air source may in this case be formed both from above through the spinneret means 5.1 or, alternatively, below the spinning device.

That which is claimed:

1. A process for producing sheath-core staple fibers with a three-dimensional crimp, said process comprising:
extruding the fibers with a symmetrical sheath-core arrangement comprising two different polymer melts with a first polymer component for the core and with a second polymer component for the sheath;
blowing the fibers with a cooling air stream directed onto the fibers on one side and having a blowing air velocity of at least 3 m/s;
combining the fibers into a tow;
treating the tow in a multistage treatment in a fiber line at temperatures below a glass transition temperature of the second polymer component; and
cutting the tow with a predetermined cutting length into staple fibers.

2. The process as claimed in claim 1, wherein the fibers are extruded with a hollow core which has a hollow portion, formed at the center, of at least 2% of the fiber cross section.

3. The process as claimed in claim 2, wherein the hollow core of the fibers is extruded with a maximum hollow portion of 30% of the fiber cross section.

4. The process as claimed in claim 2, wherein the fiber is extruded through a nozzle bore having a C-shaped orifice cross section.

5. The process as claimed in claim 1, wherein the fibers are extruded with a sheath which surrounds the core with an substantially coaxially formed annular surface in the range of 5% to 50% of the fiber cross section.

6. The process as claimed in claim 1, wherein for cooling the fibers, the cooling air has an air temperature in the range of 5° C. to 30° C.

7. The process as claimed in claim 1, further comprising extruding the fibers through a rectangular spinneret with a plurality of nozzle orifices to form a filament bundle and cooling the filament bundle by means of a cross-flow blowing arrangement, the cooling air stream being directed onto the filament bundle from outside.

8. The process as claimed in claim 1, further comprising extruding the fibers through a ring spinneret with a plurality of nozzle orifices to form a filament balloon and cooling the filament baloon by means of a candle-type blowing arrangement, the cooling air stream being directed onto the filament balloon from inside.

9. The process as claimed in claim 1, further comprising taking up the fibers, after extrusion, at a take-up speed in the range of 100 m/min. to 1000 m/min.

10. The process as claimed in claim 1, wherein the first polymer component is substantially a polyolefin and the second polymer component is substantially a polyester.

11. The process as claimed in claim 1, wherein, after treating, the fiber has a filament titer in the range of 2 den to 20 den.

12. A sheath-core staple fiber with a three-dimensional crimp, said fiber comprising:
a core having a first polymer component and a sheath having a second polymer component, wherein the two polymer components are extruded symmetrically in a fiber cross section, and wherein, within the fiber cross section, the second polymer component has a fine crystalline structure on one fiber side and a coarse crystalline structure on an opposite fiber side.

13. The sheath-core staple fiber as claimed in claim 12, wherein the core is of hollow form and has at the center a hollow portion, filled with a gaseous fluid, of at least 2% of the fiber cross section.

14. The sheath-core staple fiber as claimed in claim 13, wherein the core is extruded with a maximum hollow portion of 30% of the fiber cross section.

15. The sheath-core staple fiber as claimed in claim 12, wherein the sheath surrounds the core with a substantially coaxially formed annular surface in the range of 5% to 50% of the fiber cross section.

16. The sheath-core staple fiber as claimed in claim 12, wherein the sheath has a material density which is higher by a factor of between 1 and 1.5 than a material density of the core.

17. The sheath-core staple fiber as claimed in claim 12, wherein the first polymer component is formed by a polyolefin and the second polymer component is formed by a polyester.

18. The sheath-core staple fiber as claimed in claim 17, wherein the core is formed from a polypropylene (PP) polymer and the sheath from a polyethylene terephthalate (PET) polymer.

19. The sheath-core staple fiber as claimed in claim 12, wherein a self-crimp of the fiber lies in a range of 5 to 12 loops per 1 inch of fiber length.

20. A fibrous nonwoven product, at least a portion of which comprises staple fibers, wherein the staple fibers are formed by sheath-core staple fibers comprising a core having a first polymer component and a sheath having a second polymer component, wherein the two polymer components are extruded symmetrically in a fiber cross section, and wherein, within the fiber cross section, the second polymer component has a fine crystalline structure on one fiber side and a coarse crystalline structure on an opposite fiber side.

21. The fibrous nonwoven product as claimed in claim 20, wherein the core is of hollow form and has at the center a hollow portion, filled with a gaseous fluid, of at least 2% of the fiber cross section.

22. The fibrous nonwoven product as claimed in claim 20, wherein the core is extruded with a maximum hollow portion of 30% of the fiber cross section.

23. The fibrous nonwoven product as claimed in claim 20, wherein the sheath surrounds the core with a substantially coaxially formed annular surface in the range of 5% to 50% of the fiber cross section.

24. The fibrous nonwoven product as claimed in claim 20, wherein the sheath has a material density which is higher by a factor of between 1 and 1.5 than a material density of the core.

25. The fibrous nonwoven product as claimed in claim 20, wherein the first polymer component is formed by a polyolefin and the second polymer component is formed by a polyester.

26. The fibrous nonwoven product as claimed in claim 25, wherein the core is formed from a polypropylene (PP) polymer and the sheath from a polyethylene terephthalate (PET) polymer.

27. The fibrous nonwoven product as claimed in claim 20, wherein a self-crimp of the fiber lies in a range of 5 to 12 loops per 1 inch of fiber length.

28. The fibrous nonwoven product as claimed in claim 20, wherein the staple fibers are in the form of a carded web, the staple fibers in the web being melted together with one another at intersection points by means of a thermal consolidation process.

29. The fibrous nonwoven product as claimed in claim 20, wherein the staple fibers in the nonwoven are bonded to form a three-dimensional fiber structure.

30. The fibrous nonwoven product as claimed in claim 20, wherein the nonwoven formed from the staple fibers is designed as one of the group consisting of: heat insulation, sound insulation, and upholstery material.
